(19) United States
(12) Patent Application Publication
(10) Pub. No.: US 2012/0244414 A1
(43) Pub. Date: Sep. 27, 2012

(54) NONAQUEOUS ELECTROLYTE BATTERY AND BATTERY PACK

(76) Inventors: Hiroki INAGAKI, Kawasaki-shi (JP); Norio Takami, Yokohama-shi (JP)

(21) Appl. No.: 13/412,966

(22) Filed: Mar. 6, 2012

(30) Foreign Application Priority Data
Mar. 22, 2011 (JP) 2011-063288

(51) Int. Cl. H01M 10/056; H01M 4/485

(52) U.S. Cl. 429/149; 429/188

(57) ABSTRACT

According to one embodiment, a nonaqueous electrolyte battery including a negative electrode and a nonaqueous electrolyte is provided. The negative electrode includes a negative electrode active material having a lithium absorption potential of 1.0 V (vs Li/Li⁺) or more. The nonaqueous electrolyte includes a first compound having a functional group represented by The chemical formula (I) and a second compound having an isothiocyanato group.

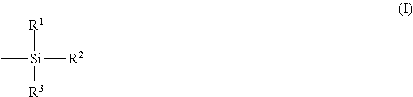

### CROSS-REFERENCE TO RELATED APPLICATIONS

This application is based upon and claims the benefit of priority from prior Japanese Patent Application No. 2011-063288, filed Mar. 22, 2011, the entire contents of which are incorporated herein by reference.

### FIELD

Embodiments described herein relate generally to a nonaqueous electrolyte battery and a battery pack.

### BACKGROUND

In recent years, a nonaqueous electrolyte battery using an active material such as a lithium-titanium composite oxide having a nobler lithium absorption potential than that of a carbonaceous material and having a lithium absorption potential of about 1.56 V vs Li/Li⁺ in a negative electrode has been studied. A lithium-titanium composite oxide is excellent in cycle characteristics since it has small change in volume in accordance with charging and discharging. Furthermore, since it is difficult to precipitate metallic lithium in principle in the lithium absorption-release reaction of a lithium-titanium composite oxide, the performance of a battery using a lithium-titanium composite oxide is deteriorated little even after charging and discharging under a large current are repeated.

### BRIEF DESCRIPTION OF THE DRAWINGS

FIG. 1 is a cross-sectional schematic view of the flat-type nonaqueous electrolyte secondary battery in an embodiment;

FIG. 2 is an enlarged cross-sectional view of the A part of FIG. 1;

FIG. 3 is a cross-sectional schematic view of the nonaqueous electrolyte secondary battery in another embodiment;

FIG. 4 is a cross-sectional schematic view of the B part of FIG. 3;

FIG. 5 is an exploded perspective view of the battery pack; and

FIG. 6 is a block diagram showing the electrical circuit of the battery pack.

### DETAILED DESCRIPTION

In general, according to one embodiment, a nonaqueous electrolyte battery comprising a positive electrode, a negative electrode and a nonaqueous electrolyte is provided. The negative electrode comprises a negative electrode active material having a lithium absorption potential of 1.0 V (vs Li/Li⁺) or more. The nonaqueous electrolyte comprises a first compound having a functional group represented by the chemical formula (I) and a second compound having an isothiocyanato group.

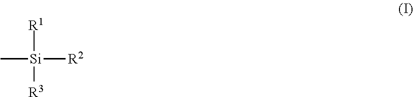

wherein R¹, R² and R³ are each an alkyl group having 1 to 10 carbon atoms, an alkenyl group having 2 to 10 carbon atoms or an aryl group having 6 to 10 carbon atoms, and R¹, R² and R³ may be the same or different with each other.

The embodiment will be hereinafter explained with reference to drawings.

### First Embodiment

In a nonaqueous electrolyte battery using a material having a high (noble) lithium absorption potential such as a lithium-titanium composite oxide, self-discharge is larger than that in a nonaqueous electrolyte battery using a carbonaceous material in a negative electrode. It is considered that this self-discharge occurs due to that the decomposition reaction of a nonaqueous electrolyte occurs continuously since it is difficult to form a stable coating on a negative electrode active material. In such case, it is considered difficult to form a stable coating not only on the negative electrode active material but also on a negative electrode conductive agent, and that the amount of self-discharge increases as the specific surface area of a negative electrode material layer (a negative electrode active material-containing layer) increases.

Furthermore, when moisture is included within the battery, the moisture and a lithium salt included in the nonaqueous electrolyte such as LiBF_{d} and LiPF₆ react to form hydrofluoric acid. The hydrofluoric acid dissolves the constitutional elements of the battery, and thus deteriorates the performance of the battery. Specifically, when a transition metal element is included in the active material of the positive electrode, the hydrofluoric acid dissolves the transition metal. The dissolved transition metal element is precipitated on the surface of the negative electrode to increase the battery resistance.

A nonaqueous electrolyte battery comprises moisture that is derived from a constitutional element or is unavoidable in production steps. Since —OH groups are readily attached to a lithium-titanium composite oxide, a battery using a lithium-titanium composite oxide may include moisture. Therefore, increase in the battery resistance is significant. Furthermore, since the amount of the adsorbed moisture increases as the specific surface area of the lithium-titanium composite oxide increases, the effect thereof also becomes more significant as the specific surface area increases.

As a method for removing the moisture included in a nonaqueous electrolyte battery, a method comprising adding an active alumina or the like to physically adsorb the moisture, and a method comprising adding an organic compound having an isothiocyanato group to a nonaqueous electrolytic solution have been suggested. However, the method comprising physically adsorbing the moisture has problems that the effect of removing the moisture is small and that the adsorbed moisture is released again at a high temperature. On the other hand, a battery resistance increases slightly according to the method using an organic compound having an isothiocyanato group. This increase in resistance is a significant problem when high input/output properties are required for the nonaqueous electrolyte battery for in-car use or the like.

Therefore, the present inventors have done intensive studies, and consequently found that it is possible to significantly suppress self-discharge and decrease a battery resistance by incorporating a first compound having a functional group represented by the following chemical formula (I) and a second compound having an isothiocyanato group in a nonaqueous electrolyte in a battery using a negative electrode comprising a negative electrode active material having a lithium absorption potential of 1.0 V (vs Li/Li⁺) or more.

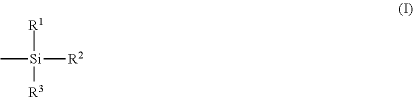

wherein R¹, R² and R³ are each an alkyl group having 1 to 10 carbon atoms, an alkenyl group having 2 to 10 carbon atoms or an aryl group having 6 to 10 carbon atoms. R¹, R² and R³ may be the same or different with each other.

Since the reduction potential is approximately 0.9 V (vs. Li/Li⁺), it is poorer than the lithium absorption potential of the negative electrode active material (this is noble by 1.0 V (vs Li/Li⁺) or more). Therefore, the second compound can react with moisture without being decomposed completely at the time of initial charging and discharging. A part of this reactant dissolves in the nonaqueous electrolyte, and a part thereof forms a thin and dense coating on the surface of the negative electrode. Since this coating is extremely stable, it can suppress a reduction reaction that is a reaction that occurs on the surface of the negative electrode between the negative electrode active material and the nonaqueous electrolyte.

If a carbon material is used as the negative electrode active material, the reduction potential of the second compound becomes a nobler potential than the lithium absorption potential of the negative electrode active material, and thus the second compound is decomposed almost completely by reduction at the time of first charging. The by-products of this decomposition by reduction excessively contaminate the surface of the negative electrode and become resistant components, thereby significantly decreasing battery performance such as charge and discharge cycle performance and large-current performance.

Thus, although the second compound is effective for removing moisture and suppressing a reduction reaction in a nonaqueous electrolyte battery using a negative electrode active material that absorber and releases lithium at a potential of 1.0 V (vs Li/Li⁺) or more, the battery resistance is slightly increased. This increase in resistance causes significant descent in voltage when high input/output properties are required for the nonaqueous electrolyte battery for in-car use or the like.

By incorporating the first compound together with this second compound in the nonaqueous electrolyte, the battery resistance can be decreased. The first compound reacts with water as shown in the following formula (A) to generate a decomposition product.

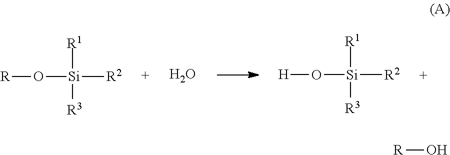

Furthermore, the first compound reacts with hydrofluoric acid as shown in the following formula (B) to generate a decomposition product.

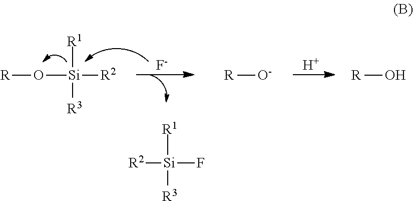

Since the first compound react quickly with water as shown in the formula (A), it has an effect of removing the moisture in the nonaqueous electrolyte, and is also expected to have an effect of trapping hydrofluoric acid as shown in the formula (B). Although the mechanism of decreasing of the battery resistance by addition of the first compound is not clear, it is considered that a coating formed by the second compound has a lower resistance and is stable due to the presence of the first compound or the decomposition products as shown in the above-mentioned formulas (A) and (B).

Therefore, by adding the first compound, the battery resistance can be decreased to lower than that of a battery to which the second compound has been added solely, and a lower battery resistance than that of a battery to which the first compound and second compound have not been added can be attained.

Therefore, by adding the first compound and second compound to the nonaqueous electrolyte, the moisture in the nonaqueous electrolyte can be removed and a stable coating can be formed on the negative electrode. At that time, an excess coating is not formed, and high input/output performance can be maintained. By the formation of a stable coating on the negative electrode, self-discharge due to the reaction between the negative electrode and nonaqueous electrolyte can be suppressed. The coating formed on the negative electrode has a small resistance, and thus the obtained battery can attain high large-current characteristics.

Furthermore, by using the nonaqueous electrolyte comprising the first compound and second compound, the charge and discharge cycle life of the nonaqueous electrolyte battery using a positive electrode active material comprising a lithium-nickel composite oxide can be improved. When a nonaqueous electrolyte that comprises the first compound but does not comprise the second compound is used as the nonaqueous electrolyte for the nonaqueous electrolyte battery using a positive electrode active material comprising a lithium-nickel composite oxide, the charge and discharge cycle life decreases. This tendency is significant when the lithium-nickel composite oxide comprises a large amount of a residual alkali component (for example, when the pH exceeds 10.8). By using the first compound and second compound in combination, the charge and discharge cycle life can be improved more than the case when these compound are not included, or the case when either one is included solely. The reason is presumed that the second compound was decomposed at the negative electrode, and the decomposition product was eluted into the electrolytic solution and also acted on the positive electrode. This is supported by the fact that a sulfur component, which is not included originally, was detected from the positive electrode. Although a detailed mechanism is unclear, it is expected to be attributed to that the second compound that has a nobler reduction decomposition potential than that of the first compound acts on the positive electrode prior to the first compound.

As mentioned above, when the second compound is used solely, the self-discharge is suppressed, but the output performance is decreased. On the other hand, when the first compound is used solely, the resistance is decreased, but the self-discharge is not suppressed. When a lithium-nickel composite oxide is used for the positive electrode active material, the charge and discharge cycle performance is also decreased. When these are used in combination, self-discharge can be suppressed as compared to the cases when they are respectively used solely, and not only the output performance but also the charge and discharge cycle life can be improved.

The decomposition product of the first compound in the nonaqueous electrolyte can be detected by a gas chromatography-mass spectrometry (GC/MS). The second compound on the surface of the negative electrode can be detected by a Fourier transform infrared spectrophotometer (FT-IR).

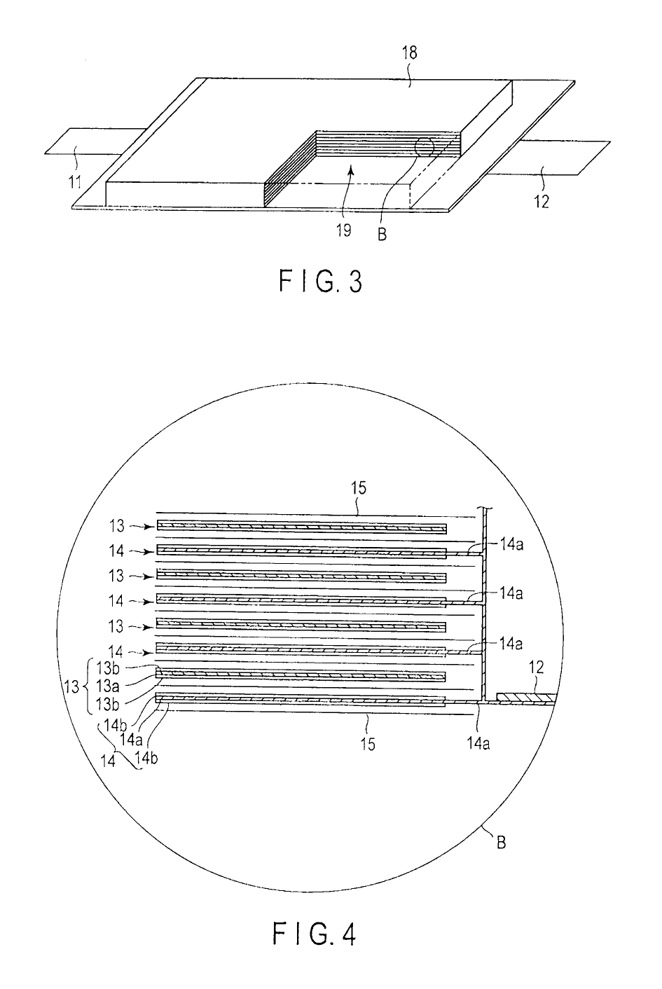

A nonaqueous electrolyte to be subjected to detection is obtained by adjusting a battery to be analyzed to a half-charged state (SOC 50%), and disintegrating and extracting the battery in an inert gas atmosphere such as an argon box. A negative electrode is collected from an electrode group in the disintegrated battery. The part to be subjected to detection in the negative electrode is defined as a portion that shows average properties among the positions that are facing a separator which is opposing to a positive electrode. For example, in the case of the wound electrode group as exemplified in FIG. 1, the part to be subjected to detection in the negative electrode is positioned around the center of the longitudinal side of the negative electrode that has been loosened from winding. And the part to be subjected to detection in the negative electrode opposes the separator which faces the positive electrode. In the case of the laminate-type electrode group as exemplified in FIG. 3, the portion that opposes to the positive electrode across the separator that is positioned on the center of the laminate direction is subjected to detection.

The analysis by GC/MS can be conducted by, for example, the following method. As an apparatus, a GC/MS (5989B) manufactured by Agilent is used, and DB-5MS (30 m×0.25 mm×0.25 μm) is used as a measurement column. The nonaqueous electrolyte can be analyzed directly, or can be analyzed after diluting with acetone, DMSO or the like.

The analysis by FT-IR can be conducted by, for example, the following method. As an apparatus, a Fourier transform FTIR apparatus: FTS-60A (manufactured by BioRad Digilab) is used. The measurement conditions are a light source: special ceramics, a detector: DTGS, a wavenumber resolution: 4 cm⁻¹, a number of accumulation: 256, and a reference: a gold-deposited film, and a diffuse reflection measurement apparatus (manufactured by PIKE Technologies) or the like can be applied as an auxiliary apparatus.

Meanwhile, not only when a transition metal element is included in the positive electrode active material but also when a transition metal element is not included, effects of improvement of a large-current discharging property and suppression of self-discharge can be obtained.

The nonaqueous electrolyte battery according to the embodiment may include a negative electrode, a nonaqueous electrolyte, a positive electrode, a separator, an outer case, a positive electrode terminal and a negative electrode terminal.

Hereinafter the nonaqueous electrolyte battery of the embodiment will be explained with reference to the drawings. Throughout the embodiments, common constitutions are assigned with the same symbol, and overlapping explanations are omitted. Also, each drawing is a schematic view for explaining the embodiment and promoting the understanding thereof, and the shape, size, ratio and the like thereof are different from those of an actual apparatus in some portions, but can be suitably designed or modified by considering the following explanation and known techniques.

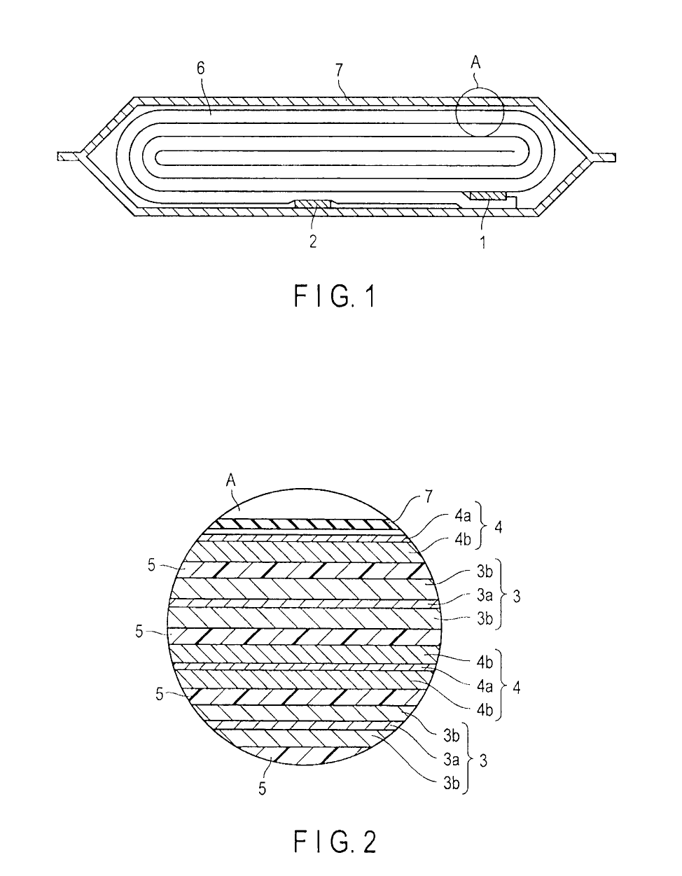

FIG. 1 is a cross-sectional view of a flat-type nonaqueous electrolyte battery that is an example of the nonaqueous electrolyte battery. FIG. 2 is an enlarged cross-sectional view of the part A of FIG. 1.

A flat wound electrode group 6 is housed in a baggy outer case 7 composed of a laminate film comprising two resin layers and a metal layer interposed therebetween. The flat wound electrode group 6 is formed by rolling-up a laminate in which a negative electrode 1, a separator 5, a positive electrode 3 and a separator 5 are laminated in this order from the outer side in a spiral shape and subjecting the laminate to press forming.

The negative electrode 4 comprises a negative electrode current collector 4a and a negative electrode material layer (negative electrode active material-containing layer) 4b. As shown in FIG. 2, the negative electrode 4 on the outermost layer has a constitution in which the negative electrode material layer 4b is formed on one surface on the inner surface side of the negative electrode current collector 4a. In another negative electrode 4, the negative electrode material layers 4b are formed on the both surfaces of the negative electrode current collector 4a. In the positive electrode 3, positive electrode layers (positive electrode active material-containing layer) 3b are formed on the both surfaces of a positive electrode current collector 3a.

In the vicinity of the outer circumferential end of the wound electrode group 6, a negative electrode terminal 2 is connected to the negative electrode current collector 4a of the negative electrode 4 of the outermost layer, and a positive electrode terminal 1 is connected to the positive electrode current collector 3a of the positive electrode 3 on the inner side. These negative electrode terminal 2 and positive electrode terminal 1 are extending from the opening of the baggy outer case 7 to outside. A nonaqueous electrolytic solution as the nonaqueous electrolyte is injected from, for example, the opening of the baggy outer case 7. By interposing the negative electrode terminal 2 and positive electrode terminal 1 into the opening of the baggy outer case 7 and heat-sealing, the wound electrode group 6 and nonaqueous electrolytic solution are sealed off completely.

Hereinafter the negative electrode, nonaqueous electrolyte, positive electrode, separator, outer case, positive electrode terminal and negative electrode terminal are explained in detail.

### 1) Negative Electrode

The negative electrode comprises a current collector, and a negative electrode material layer(s) comprising an active material (negative electrode active material-containing layer[s]) that is/are formed on one surface or both surfaces of the current collector. The negative electrode material layer may comprise a conductive agent and a binder.

As the negative electrode active material, a negative electrode active material having a lithium absorption potential of 1.0 V (vs. Li/Li⁺) or nobler than 1.0 V (vs. Li/Li⁺) is used. When a carbonaceous material that stores lithium at a poorer potential than the decomposition potential of second compound, for example, at a decomposition potential poorer than 1.0 V (vs. Li/Li⁺), is used for the negative electrode active material, the second compound is excessively decomposed by reduction and forms an excess coating having a high resistance on the surface of the negative electrode, thereby deteriorating the battery performance. Furthermore, a large amount of gas is generated due to the excessive decomposition reactions of these compounds themselves, which leads to deformation of the battery. It is preferable that the negative electrode active material has a lithium absorption potential of 1 to 3 V (vs. Li/Li⁺) so as to increase the battery voltage.

The negative electrode active material having a lithium absorption potential of 1.0 V (vs Li/Li⁺) or more is preferably a lithium-titanium composite oxide. Since the lithium-titanium composite oxide stores lithium at around 1.5 V (vs. Li/Li⁺), excess reductive decomposition of the second compound can be avoided.

Examples of the lithium-titanium composite oxide include, for example, lithium-titanium oxides such as cubic system spinel types Li₄₊ₓTi₅O₁₂ (0≦x≦3) and orthorhombic system ramsdellite types Li_{2+y}Ti₃O₇ (wherein y is 0≦y≦3), lithium-titanium composite oxides obtained by substituting a part of the constitutional elements of a lithium-titanium oxides with a heterologous element. From the viewpoint of charge and discharge cycle life, lithium-titanium oxides of cubic system spinel types having small change in a lattice volume due to absorb and release of lithium are preferable.

Other examples of the negative electrode active material include lithium-niobium composite oxides such as LiₓNb₂O₅ (0≦x≦2) and LiₓNbO₃ (0≦x≦1), which have a lithium absorption potential of 1 to 2 V (vs. Li/Li⁺), lithium-molybdenum composite oxides such as LiₓMoO₃ (0≦x≦1), which have a lithium absorption potential of 2 to 3 V (vs. Li/Li⁺), lithium-iron composite sulfides such as LiₓFeS₂ (0≦x≦4), which have a lithium absorption potential of 1.8 V (vs. Li/Li⁺), and the like.

Furthermore, as the negative electrode active material, a titanium oxide such as TiO₂, or a metal composite oxide comprising Ti and at least one kind of element selected from the group consisting of P, V, Sn, Cu, Ni, Co and Fe can also be used. These oxides store lithium during the charging at the first cycle to become a lithium-titanium composite oxide. TiO₂ is preferably one having a monoclinic system β type (also referred to as a bronze type or TiO₂(B)), a heat treatment temperature of 300 to 500° C. and low crystallinity.

Examples of the metal composite oxide comprising Ti and at least one kind of element selected from the group consisting of P, V, Sn, Cu, Ni, Co and Fe include, for example, TiO₂—P₂O₅, TiO₂-V₂O₅, TiO₂-P₂O₅—SnO₂ and TiO₂—P₂O₅—MeO (wherein Me is at least one kind of element selected from the group consisting of Cu, Ni, Co and Fe). This metal composite oxide preferably has a micro structure in which a crystal phase and an amorphous phase are present together, or an amorphous phase is present solely. By having such micro structure, the cycle performance can be improved significantly.

For the negative electrode active material, the above-mentioned active materials may be used solely, or may be used by mixing.

It is desirable that the negative electrode active material has an average primary particle size of 1 μm or less. Furthermore, by adjusting the average primary particle size to 0.001 μm or more, the deviation of distribution of the nonaqueous electrolyte can be decreased, thereby suppressing depletion of the nonaqueous electrolyte in the positive electrode. Therefore, the lower limit of the average primary particle size thereof is preferably 0.001 μm or more.

It is desirable that the negative electrode active material has an average primary particle size of 1 μm or less, and has a specific surface area by a BET method by N₂ adsorption in the range of 5 to 50 m²/g. By doing so, the impregnation property of the nonaqueous electrolyte can be increased.

As the specific surface area of the negative electrode active material increases, the effect of suppressing self-discharge and the effect of improving large-current performance are increased. The reason is that the higher the affinity between the lithium-titanium composite oxide and water is and the larger the specific surface area is, the larger the amount of moisture brought into a cell is.

The negative electrode desirably has a porosity (except for the current collector) in the range of 20 to 50%. By doing so, a negative electrode that is excellent in the affinity between the negative electrode and nonaqueous electrolyte and has a high density can be obtained. The porosity is more preferably in the range of 25 to 40%.

The negative electrode preferably has a density of 1.8 g/cc or more. By doing so, the porosity can be adjusted to the above-mentioned range. A more preferable range of the negative electrode density is from 1.8 to 2.5 g/cc.

The negative electrode current collector is preferably an aluminum foil or an aluminum alloy foil. The negative electrode current collector preferably has an average crystal particle size of 50 μm or less. By doing so, the strength of the current collector can be increased, and thus the negative electrode can be highly densified under a high pressing pressure and the battery capacity can be increased. Furthermore, since deterioration of the current collector by dissolution and corrosion in over-discharge cycles under a high-temperature environment (40° C. or more) can be prevented, rise in a negative electrode impedance can be suppressed. Moreover, the output characteristics, high-speed charge and charge and discharge cycle characteristics can also be improved. A more preferable range of the average crystal grain size is 30 μm or less, and a further preferable range thereof is 5 μm or less.

The average crystal grain size is obtained as follows. The structure of the surface of the current collector is observed by an optical microscope to find the number n of crystal grains present in an area of 1 mm×1 mm. Using this n, an average crystal grain area S is obtained from S=1×10⁶/n (μm²). Then, an average crystal grain size d (μm) is calculated from the obtained value of S by the following equation (C).

d=2(S/π)^{1/2} (C)

An aluminum foil or an aluminum alloy foil having an average crystal grain size in the range of 50 μm or less is affected by many factors such as compositions of materials, impurities, process conditions, heat treatment history and heating conditions for annealing, and a crystal grain size (diameter) is adjusted by combining various factors in production steps.

The aluminum foil or aluminum alloy foil has a thickness of, preferably 20 μm or less, more preferably 15 μm or less. The aluminum foil preferably has a purity of 99% by mass or more. As the aluminum alloy, alloys comprising elements such as magnesium, zinc and silicon are preferable. On the other hand, the content of the transition metal such as iron, copper, nickel and chromium is preferably adjusted to 1% by mass or less.

The negative electrode material layer (negative electrode active material-containing layer) can comprise a conductive agent. As the conductive agent, for example, carbon materials, metal powders such as an aluminum powder, and conductive ceramics such as TiO can be used. Examples of the carbon material include acetylene black, carbon black, coke, carbon fibers and graphite. More preferably, powders of coke, graphite and TiO each having an average particle size of 10 μm or less and carbon fibers having an average particle size of 1 μm or less, which have a heat treatment temperature of 800 to 2,000° C., are used. The carbon material preferably has a specific surface area by a BET method by N₂ adsorption of 10 m²/g or more.

The negative electrode material layer (negative electrode active material-containing layer) can comprise a binder. Examples of the binder include polytetrafluoroethylene (PTFE), polyvinylidene fluoride (PVdF), fluorine-based rubbers, styrene-butadiene rubbers and core-shell binders.

With respect to the mixing ratio of the negative electrode active material, negative electrode conductive agent and binder, it is preferable that the negative electrode active material is in the range of 70% by mass to 96% by mass, the negative electrode conductive agent is in the range of 2% by mass to 28% by mass, and the binder is in the range of 2% by mass to 28% by mass. By adjusting the amount of the negative electrode conductive agent to 2% by mass or more, the current collecting performance of the negative electrode material layer can be improved, and the large-current characteristics of the nonaqueous electrolyte battery can be improved. Furthermore, by adjusting the amount of the binder to 2% by mass or more, the binding property between the negative electrode material layer and the negative electrode current collector becomes sufficient, thereby obtaining high cycle characteristics. On the other hand, the amounts of the negative electrode conductive agent and binder are respectively preferably 28% by mass or less in view of attaining a high capacity.

The negative electrode is prepared by, for example, suspending the negative electrode active material, negative electrode conductive agent and binder in a general purpose solvent to prepare slurry, applying the slurry to the negative electrode current collector and drying to prepare a negative electrode material layer (negative electrode active material-containing layer), and pressing the negative electrode material layer.

### 2) Nonaqueous Electrolyte

As the nonaqueous electrolyte, for example, a nonaqueous electrolytic solution can be used. The nonaqueous electrolytic solution comprises a nonaqueous solvent, an electrolyte, the first compound having a functional group represented by the following chemical formula (I), and the second compound having an isothiocyanato group. The first and second compounds may be dissolved in a nonaqueous solvent when they are solids, or may be mixed with a nonaqueous solvent when they are liquids. The electrolyte is dissolved in the nonaqueous solvent, and the concentration of the electrolyte in the nonaqueous solvent is preferably adjusted to from 0.5 mol/L to 2.5 mol/L.

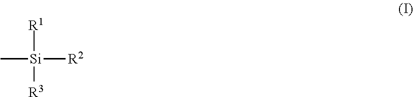

wherein R¹, R² and R³ are each an alkyl group having 1 to 10 carbon atoms, an alkenyl group having 2 to 10 carbon atoms or an aryl group having 6 to 10 carbon atoms. R¹, R² and R³ may be the same or different with each other.

The first compound is a compound having three, two or one functional group(s) represented by the chemical formula (I). The first compound is preferably a phosphate compound having a functional group represented by the chemical formula (I) or a borate compound having a functional group represented by the chemical formula (I). The phosphate compound and borate compound are each added to the nonaqueous electrolyte, and decomposed by reduction to generate lithium phosphate and lithium borate, respectively. These compounds are stabilized on the surface of the negative electrode, and can contribute to formation of a high-quality coating. Specifically, a phosphate compound represented by the following chemical formula (IV) is preferable. According to the phosphate compound represented by the chemical formula (IV), a high-quality coating can be formed on the surface of the positive electrode.

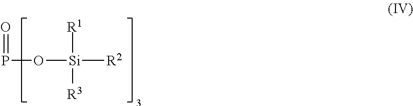

wherein R¹, R² and R³ are each an alkyl group having 1 to 10 carbon atoms, an alkenyl group having 2 to 10 carbon atoms or an aryl group having 6 to 10 carbon atoms. R¹, R² and R³ may be the same or different with each other. The functional groups that are preferable as R¹, R² and R³ are a methyl group and an ethyl group. By these groups, the effect of suppressing self-discharge and the effect of improving input/output performance can further be improved.

The phosphate compound is preferably a silyl phosphate ester, and for example, tris(trimethylsilyl) phosphate (TMSP) represented by the following chemical formula (V) can be used.

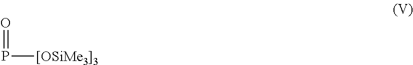

The tris(trimethylsilyl) phosphate that has been added to the nonaqueous electrolyte and has been decomposed to generate fluorotrimethylsilane ((CH₃)₃SiF). Therefore, fluorotrimethylsilane ((CH₃)₃SiF) can also be used as the first compound to be added. By using both tris(trimethylsilyl) phosphate and fluorotrimethylsilane, the effect of suppressing self-discharge can be improved.

In addition, also when tris(trimethylsilyl) borate is used as the borate compound, for example, tris(trimethylsilyl) borate is decomposed in a similar manner to generate fluorotrimethylsilane ((CH₃)₃SiF).

Examples of the first compound having three functional groups represented by the above-mentioned chemical formula (I) include tris(trimethylsilyl) phosphate, tris(triethylsilyl) phosphate, and tris(vinyldimethylslyl) phosphate, tris(trimethylsilyl) borate and tris(triethylsilyl) borate. Specifically, tris(trimethylsilyi) phosphate is preferably used.

Examples of the first compound having two functional groups represented by the above-mentioned chemical formula (I) include bis(trimethylsilyl)methylphosphate, bis(trimethylsilyl)ethyl phosphate, bis(trimethylsilyl)-n—propyl phosphate, bis(trimethylsilyl)-1-propyl phosphate, bis(trimethylsilyl)-n-butyl phosphate, bis(trimethylsilyl) trichloroethyl phosphate, bis(trimethylsilyl) trifluoroethyl phosphate, bis(trimethylsilyl) pentafluoropropyl phosphate and bis(trimethylsilyl)phenyl phosphate.

Examples of the first compound having one functional group represented by the above-mentioned chemical formula (I) include dimethyl trimethylsilyl phosphate, diethyl trimethylsilyl phosphate, di-n-propyl trimethylsilyl phosphate, di-1-propyl trimethylsilyl phosphate, di-n-butyl trimethylsilyl phosphate, bis(trichloroethyl) trimethylsilyl phosphate, bis(trifluoroethyl) trimethylsilyl phosphate, bis(pentafluoropropyl) trimethylsilyl phosphate and diphenyl trimethylsilyl phosphate.

As the first compound, the compounds listed above may be added solely, or a combination of plural compounds may be added.

The second compound may be any one as long as it is a compound having an isothiocyanato group. Although a cyclic organic compound may be used, a chain organic compound is desirable in view of effects on environments, and the second compound represented by the following chemical formula (II) or (III) is preferable since it is excellent in the effect of suppressing self-discharge and the effect of improving large-current performance.

R-NCS (II)

NCS-R-NCS (III)

wherein R is a chain hydrocarbon group having 1 to 10 carbon atoms.

The smaller the molecular weight of the second compound is, a larger effect can be obtained by a small added amount. When the added amount is small, the possibility of changing the characteristics of the nonaqueous electrolyte such as conductivity is small. Therefore, the R in the above-mentioned formula (II) and (II) is more preferably a chain hydrocarbon group having 1 to 8 carbon atoms. Furthermore, the second compound is more preferably a compound represented by the chemical formula (III). This is because the effect of removing moisture is doubled by having two isothiocyanato groups. By using a compound having a higher effect of removing moisture, moisture can be removed sufficiently even when the amount of the moisture in the cell increases.

Examples of the second compound include 1,2-diisothiocyanatoethane, 1,3-diisothiocyanatopropane, 1,4-diisothiocyanatobutane, 1,4-diisothiocyanatobenzene, 1,5-diisothiocyanatopentane, 1,6-diisothiocyanatohexane, 1,7-diisothiocyanatoheptane, 1,8-diisothiocyanatoctane, 1-isothiocyanatohexane, 1-isothiocyanatobutane and ethyl isocyanate. A preferable second compound is at least one compound selected from the group consisting of 1,2-diisothiocyanatoethane, 1,3-diisothiocyanatopropane, 1,4-diisothiocyanatobutane, 1,4-diisothiocyanatobenzene, 1,5-diisothiocyanatopentane, 1,6-diisothiocyanatohexane, 1,7-diisothiocyanatoheptane and 1,8-diisothiocyanatoctane. All of these compounds are readily available and are excellent in the effect of suppressing self-discharge and the effect of improving input/output performance. Most preferably, 1,6-diisothiocyanatohexane is used.

In the nonaqueous electrolyte, the first compound slightly reacts at a nobler potential than the decomposition potential of the second compound. Therefore, it is considered that the first compound has an effect of suppressing excess decomposition of the second compound. Namely, it is considered that formation of a coating occurs in preference to the decomposition reaction of the second compound. It is considered that this coating has a small charge transfer resistance and enables smooth absorption and release of lithium ions to the inside of the negative electrode, thereby decreasing the initial resistance of the battery.

The content of the first compound in the nonaqueous electrolyte is preferably 0.05% by mass or more. By adding by 0.05% by mass or more, a resistance suppression effect can be obtained. Since the resistance suppression effect is increased as the content of the first compound increases, the content is preferably 0.1% by mass or more. On the other hand, since the first compound has a low conductivity, if it is added excessively, the large-current performance of the battery may decrease. Therefore, the content of the first compound in the nonaqueous electrolyte is preferably 5% by mass or less, more preferably 3% by mass or less.

The content of the second compound in the nonaqueous electrolyte is preferably in the range of 0.05 to 2% by mass, more preferably in the range of 0.1 to 1% by mass. By adding the second compound by 0.05% by mass or more, the effect of suppressing self-discharge can be obtained for a long period. By adjusting the added amount to 2% by mass or less, large-current performance can be maintained without decreasing the conductivity of the nonaqueous electrolyte.

As the electrolyte, for example, lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethasulfonate (LiCF₃SO₃) or bistrifluoromethylsulfonylimide lithium [LiN(CF₃SO₂)₂] can be used. Electrolytes that are hardly oxidized even at a high potential are preferable, and LiBE₄ or LiPF₆ is the most preferable. The electrolytes may be used solely by one kind, or a combination of two or more kinds may be used.

As the nonaqueous solvent, for example, cyclic carbonates such as propylene carbonate (PC), ethylene carbonate (EC) and vinylene carbonate; chain carbonates such as diethyl carbonate (DEC), dimethyl carbonate (DMC) and methyl ethyl carbonate (MEC); cyclic ethers such as tetrahydrofuran (THE), 2-methyltetrahydrofuran (2MeTHF) and dioxolan (DOX); chain ethers such as dimethoxyethane (DMP) and diethoxyethane (DEE); γ-butyrolactone (GBL), acetonitrile (AN) or sulfolane (SL) can be used solely or as a combination.

Preferably, a mixed solvent obtained by mixing at least two or more kinds selected from the group consisting of propylene carbonate (PC), ethylene carbonate (EC) and γ-butyrolactone (GBL) is used. More preferably, a mixed solvent obtained by mixing γ-butyrolactone (GEL) and other solvent is used. The reason is as follows.

First, γ-butyrolactone, propylene carbonate and ethylene carbonate have a high boiling point and a high ignition point, and thus are excellent in heat stability.

Second, γ-butyrolactone is reduced more easily than chain carbonates and cyclic carbonates are. Specifically, easiness of reduction is decreased in the order of γ-butyrolactone>>>ethylene carbonate>propylene carbonate>>dimethyl carbonate>methyl ethyl carbonate>diethyl carbonate. It is shown that the larger the number of > is, the greater the difference in reactivity between solvents is.

γ-Butyrolactone is slightly reduced and decomposed at the action potential area of the lithium-titanium composite oxide in the nonaqueous electrolyte. This decomposition product forms a further stable coating together with an amino compound on the surface of the lithium-titanium oxide. The same applies to the mixed solvent mentioned above. Therefore, a solvent that is reduced more easily is used more preferably.

In order to form a higher-quality coating on the surface of the negative electrode, the content of γ-butyrolactone is preferably from 40% by volume to 95% by volume with respect to the nonaqueous solvent.

Although the nonaqueous electrolyte comprising γ-butyrolactone shows the above-mentioned excellent effects, it has a high viscosity and a low impregnating property against electrodes. However, when the negative electrode active material having an average particle size of 1 μm or less is used, impregnation of the nonaqueous electrolyte can be conducted smoothly even a nonaqueous electrolyte comprising γ-butyrolactone is used. Therefore, the productivity can be improved, and the output property and charge and discharge cycle properties can be improved.

### 3) Positive Electrode

The positive electrode comprises a positive electrode current collector, and positive electrode material layer(s) comprising a positive electrode active material and optionally comprising a positive electrode conductive agent and a binder (positive electrode active material-containing layer[s]) that is/are formed on one surface or both surfaces of the positive electrode current collector.

As the positive electrode active material, for example, an oxide, a sulfide and a polymer can be used.

Examples of the oxide include manganese dioxide (MnO₂), iron oxide, copper oxide and nickel oxide that can store and release Li, and lithium-manganese composite oxides (for example, LiₓMn₂O₄ or LiₓMnO₂), lithium-nickel composite oxides (for example, LₓNiO₂), lithium-cobalt composite oxides (for example, Liₓ CoO₂), lithium-nickel-cobalt composite oxides (for example, LiNi_{1-y} Co_{y}O₂), lithium-manganese-cobalt composite oxides (for example, LiMn_{y} Co_{1-y}O₂), spinel-type lithium-manganese nickel composite oxides (for example, LiₓMn_{2-y}Ni_{y}O₄), lithium phosphorous oxides having an olivine structure (for example, LiₓFePO₄, LiₓFe_{1-y}Mn_{y}PO₄ and Liₓ CoPO₄ and the like), iron sulfates [Fe₂(SO₄)₃], vanadium oxides (for example, V₂O₅) and lithium-nickel-cobalt-manganese composite oxides. Here, x and y are preferably in the range of 0 to 1.2.

Examples of the polymer include conductive polymer materials such as polyanilines and polypyrroles, and disulfide-based polymer materials. Beside that, sulfur (S) and carbon fluorides can also be used.

Examples of the positive electrode active material by which a high positive electrode potential can be obtained include lithium-manganese composite oxides (for example, LiₓMn₇O₄), lithium-nickel composite oxides (for example, LiₓNiO₂), lithium-cobalt composite oxides (for example, Liₓ CoO₂), lithium-nickel-cobalt composite oxides (for example, LiₓNi_{1-y} Co_{y}O₂), spinel-type lithium-manganese-nickel composite oxides (for example, LiₓMn_{2-y}Ni_{y}O₄), lithium-manganese-cobalt composite oxides (for example, LiₓMn_{y} Co_{1-y}O₂), lithium phosphate irons (for example, LiₓPePO₄) and lithium-nickel-cobalt-manganese composite oxides and the like. Here, x and y are preferably in the range of 0 to 1.2.

As mentioned above, in the embodiment, a high effect is shown when a lithium-transition metal composite oxide comprising nickel is applied among the above-mentioned positive electrode active materials. Specifically, it is specifically effective when the value of pH is measured by putting 2 g of the active material in 100 g of distilled water, and exceeds 10.0.

When a lithium-transition metal composite oxide such as LiCoO₂ and LiMn₇O₄ is used as the positive electrode active material, the second compound may be slightly decomposed by oxidization and contaminate the surface of the positive electrode. In this case, it is preferable to cover a part or entirety of the surfaces of the particles of the lithium-transition metal composite oxide by an oxide of at least one kind of element of Al, Mg, Zr, B, Ti and Ga. By doing so, even when the second compound is included in the nonaqueous electrolyte, the oxidative decomposition of the nonaqueous electrolyte on the surface of the positive electrode active material can be suppressed. Therefore, contamination on the surface of the positive electrode can be alleviated, and a nonaqueous electrolyte battery having a longer life can be obtained.

As the oxide used for coating, for example, Al₂O₃, MgO, ZrO₂, B₂O₃, TiO₂ or Ga₂O₃ can be used. The oxide is included by, but is not limited to, preferably from 0.1 to 15% by mass, more preferably from 0.3 to 5% by mass with respect to the amount of the lithium-transition metal composite oxide. By adjusting the oxide used for coating to 0.1% by mass or more, the oxidative decomposition of the nonaqueous electrolyte on the surface of the lithium-transition metal composite oxide can be suppressed. Furthermore, by adjusting the oxide used for coating to 15% by mass or less, a lithium ion battery having a high capacity can be attained.

Furthermore, the lithium-transition metal composite oxide may comprise lithium-transition metal composite oxide particles to which an oxide used for coating as mentioned above has attached, and lithium-transition metal composite oxide particles to which these oxides have not attached.

The oxide used for coating is preferably MgO, ZrO₂ or B₂O₃. By using the lithium-transition metal composite oxide to which these oxide have attached as the positive electrode active material, a charging voltage can further be raised to, for example, 4.4 V (vs Li/Li⁺) or more, thereby improving charge and discharge cycle characteristics.

The composition of the lithium-transition metal composite oxide may comprise other unavoidable impurities.

Coating of the lithium-transition metal composite oxide can be conducted as follows. First, grains of the lithium-transition metal composite oxide are impregnated with an aqueous solution comprising ions of element M. By calcining the obtained impregnated lithium-transition metal composite oxide particles, lithium-transition metal composite oxide particles coated with an oxide of element M can be obtained. The element M is at least one kind of element selected from the group consisting of Al, Mg, Zr, B, Ti and Ga.

The form of the aqueous solution used for the impregnation is not specifically limited as long as it enables attaching of the oxide of the element M (at least one kind of element from Al, Mg, Zr, B, Ti and Ga) to the surface of the lithium-transition metal composite oxide after calcination, and an aqueous solution comprising at least one kind of element from Al, Mg, Zr, B, Ti and Ga having a suitable form can be used. The form of these metals (including boron) may be an oxynitrate, nitrate, acetate, sulfate, carbonate, hydroxide or acid, or the like of at least one element selected from Al, Mg, Zr, B, Ti and Ga.

As mentioned above, since the oxide used for coating is preferably MgO, ZrO₂ or B₂O₃, the ion of the element M is more preferably Mg ion, Zr ion or B ion. As examples of the aqueous solution comprising the ion of the element M, an Mg(NO₃)₂ aqueous solution, a ZrO(NO₃)₂ aqueous solution, a ZrCO₄.ZrO₂.8H₂O aqueous solution, a Zr(SO₄)₂ aqueous solution or a H₃BO₃ aqueous solution is more preferable, of which an Mg(NO₃)₂ aqueous solution, ZrO(NO₃)₂ aqueous solution or H₃BO₃ aqueous solution is the most preferable.

Although the concentration of the ion aqueous solution of the element M is not specifically limited, a saturated solution is preferable. By using a saturated solution, the volume of the solution can be decreased in the impregnation step.

The form of the ion of the element M in the aqueous solution may be not only an ion consisting of a simple substance of the element M but also a form of an ion that is binding to other element. As an example for boron, for example, B(OH)₄— may be used.

The mass ratio of the lithium-transition metal composite oxide and the element M in the impregnation step is not specifically limited, and may be a mass ratio corresponding to the composition of a lithium-transition metal composite oxide to be produced. The time for impregnation may be a period in which impregnation is conducted sufficiently, and the temperature for impregnation is also not specifically limited.

Although the temperature and time for calcination can be suitably determined, they are preferably from 400 to 800° C. and from 1 to 5 hours, and specifically preferably 600° C. and 3 hours. Calcination may also be conducted under an oxygen flow or in the air. Although the particles after the impregnation may be calcined directly, it is preferable to dry the particles before the calcination so as to remove the moisture in the mixture. The drying as used here can be conducted by a generally-known method, and can be conducted by using singly or in combination, for example, heating in an oven, drying by hot air, and the like. Furthermore, it is preferable to conduct drying in an atmosphere such as oxygen or air.

The thus-obtained coated lithium-transition metal composite oxide may be pulverized as necessary.

The primary particle size of the positive electrode active material is preferably from 100 nm to 1 μm. When the particle size is 100 nm or more, handling is easy in industrial production. When the particle size is 1 μm or less, diffusing of lithium ions in a solid can be promoted smoothly.

The specific surface area of the positive electrode active material is preferably from 0.1 m²/g to 10 m²/g. When the specific surface area is 0.1 m²/g or more, absorbing and release sites for lithium ions can be ensured sufficiently. When the specific surface area is 10 m²/g or less, handling is easy in industrial production, and high charge and discharge cycle performance can be ensured.

As the positive electrode conductive agent for increasing the current-collecting performance and suppressing the contact resistance with the current collector, carbonaceous materials such as acetylene black, carbon black and graphite can be used.

As the binder for binding the positive electrode active material with the positive electrode conductive agent, for example, polytetrafluoroethylene (PTFE), polyvinylidene fluoride (PVdF) and fluoro-based rubbers can be used.

The mix ratio of the positive electrode active material, positive electrode conductive agent and binder is preferably from 80% by mass to 95% by mass of the positive electrode active material, 3% by mass to 18% by mass of the positive electrode conductive agent, and 2% by mass to 17% by mass of the binder. The positive electrode conductive agent can exert the above-mentioned effects by being incorporated by 3% by mass or more, and can decrease the decomposition of the nonaaueous electrolyte on the surface of the positive electrode conductive agent under storage at a high temperature by being incorporated by 18% by mass or less. The binder can provide a sufficient electrode strength by being incorporated by 2% by mass or more, and can decrease the incorporation amount of an insulating body in the electrode and thus can decrease the internal resistance by being incorporated by 17% by mass or less.

For the positive electrode, for example, the positive electrode active material, positive electrode conductive agent and binder are suspended in a suitable solvent to prepare slurry. This slurry is applied to the positive electrode current collector and dried to form a positive electrode material layer (a positive electrode active material-containing layer), and the positive electrode material layer is then pressed, thereby preparing the positive electrode. Alternatively, the positive electrode active material, positive electrode conductive agent and binder may be formed into a pellet form and used as the positive electrode material layer (positive electrode active material-containing layer).

The positive electrode current collector is preferably an aluminum foil or aluminum alloy foil, and the average crystal grain size thereof is preferably 50 μm or less as in the negative electrode current collector. More preferably, it is 30 μm or less. Further preferably, it is 5 μm or less. Since the average crystal grain size is 50 μm or less, the strength of the aluminum foil or aluminum alloy foil can be increased and the positive electrode can be densified under a high pressure, thereby increasing battery capacity.

An aluminum foil or an aluminum alloy foil having an average crystal grain size of 50 μm or less is affected by many factors such as tissues of materials, impurities, process conditions, heat treatment history and heating conditions for annealing, and the crystal grain size is adjusted by combining various factors in production steps.

The aluminum foil or aluminum alloy foil has a thickness of, preferably 20 μm or less, more preferably 15 μm or less. The aluminum foil preferably has a purity of 99% by mass or more. As the aluminum alloy, alloys comprising elements such as magnesium, zinc and silicon are preferable. On the other hand, the content of the transition metal such as iron, copper, nickel and chromium is preferably adjusted to 1% by mass or less.

### 4) Separator

As the separator, a porous film including polyethylene, polypropylene, cellulose or polyvinylidene fluoride (PVdF), or a nonwoven fabric made of a synthetic resin can be used. Since cellulose has hydroxyl groups at the terminals, it easily brings moisture into a cell. Therefore, when a separator comprising cellulose is used, the effect according to the embodiment is exerted more.

The separator preferably has a pore median diameter by a mercury porosimetry of 0.15 to 2 μm. By adjusting the pore median diameter to 0.15 μm or more, the film resistance of the separator is small, and a high output can be obtained. When it is 2 μm or less, the shutdown of the separator occurs evenly, thereby attaining high safety. In addition, diffusion of the nonaqueous electrolyte by a capillary phenomenon is promoted, thereby preventing deterioration of the cycles due to depletion of the nonagueous electrolyte. A more preferable range is from 0.10 to 0.40 μm.

The separator preferably has a pore mode diameter by a mercury porosimetry of 0.12 to 1.0 μm. Since the pore mode diameter is 0.12 μm or more, the film resistance of the separator is small and a high output can be obtained; furthermore, denaturation of the separator under an atmosphere at a high temperature and a high voltage is prevented and a high output can be obtained. Furthermore, since it is 1.0 μm or less, the shutdown of the separator occurs evenly, thereby attaining high safety. A more preferable range is from 0.18 to 0.35 μm.

The separator preferably has a porosity of 45 to 75%. Since the porosity is 45% or more, the absolute amount of the ions in the separator is sufficient, and a high output can be obtained. Furthermore, since the porosity is 75% or less, the separator has a high strength and shutdown occurs evenly, thereby attaining high safety. A more preferable range is from 50 to 65%.

### 5) Outer Case

As the outer case, a container made of a laminate film having a wall thickness of 0.2 mm or less or a metal having a wall thickness of 1 mm or less can be used. More preferably, the container made of a metal has a wall thickness of 0.5 mm or less.

The shape may be a flat type, a square type, a cylinder type, a coin type, a button type, a sheet type or a laminate type. Alternatively, it may also be a small-sized battery to be mounted on portable electronic devices and the like, or a large-sized battery to be mounted on two- to four-wheel vehicles and the like.

The laminate film is a multilayer film comprising metal layers and resin layers by which the metal layers are coated. The metal layer is preferably an aluminum foil or aluminum alloy foil for weight saving. The resin layer is used for reinforcing the metal layer, and polymers such as polypropylene (PP), polyethylene (PE), nylon and polyethylene telephthalate (PET) can be used. The laminate film is formed by sealing by thermal fusion bonding.

For the container made of a metal, aluminum or an aluminum alloy can be used. As the aluminum alloy, alloys comprising elements such as magnesium, zinc and silicon are preferable. On the other hand, the content of the transition metal such as iron, copper, nickel and chromium is preferably 1% by mass or less. By doing so, long-term reliability under a high temperature atmosphere and heat radiation property can be improved dramatically.

A metal can composed of aluminum or an aluminum alloy preferably has an average crystal grain size of 50 μm or less. More preferably, it is 30 μm or less. Further preferably, it is 5 μm or less. By adjusting the average crystal grain size to 50 μm or less, the strength of the metal can composed of the aluminum foil or aluminum alloy foil can be increased outstandingly. Furthermore, the well thickness of the can further be decreased. As a result, a battery having a light weight, providing high output and having excellent long term reliability, which is suitable for in-car use, can be provided.

### 6) Negative Electrode Terminal

The negative electrode terminal can be formed from a material having electric stability and conductivity in a potential range of 0.4 V or more and 3 V or less with respect to a lithium metal. Specific examples may include aluminum alloys containing elements such as Mg, Ti, Zn, Mn, Fe, Cu and Si, and aluminum. In order to decrease contact resistance, a similar material to that of the negative electrode current collector is preferable.

### 7) Positive Electrode Terminal

The positive electrode terminal can be formed from a material having electric stability and conductivity at a potential against a lithium metal in the range of 3 to 5 V. Specific examples may include aluminum alloys containing elements such as Mg, Ti, Zn, Mn, Fe, Cu and Si, and aluminum. In order to decrease contact resistance, a similar material to that of the positive electrode current collector is preferable.

FIG. 3 shows another example of the nonaqueous electrolyte battery. FIG. 3 is a partially cutaway view of the flat-type nonaqueous electrolyte battery. FIG. 4 is an enlarged sectional view of the B part of FIG. 3.

A laminate-type electrode group 19 is housed in an outer case 18 composed of a laminate film comprising two resin layers and a metal layer interposed therebetween. As shown in FIG. 4, the laminate-type electrode group 19 has a structure in which positive electrodes 13 and negative electrodes 14 are alternately laminated with separators 15 interposed therebetween. Plural positive electrodes 13 are present, and each of which comprises a positive electrode current collector 13a and positive electrode material layers 13b (positive electrode active material-containing layer) that are formed on the both surfaces of the positive electrode current collector 13a. Plural negative electrodes 19 are present, and each of which comprises a negative electrode current collector 14a and negative electrode material layers (negative electrode active material-containing layers) 14b that are formed on the both surfaces of the negative electrode current collector 14a. One side of the negative electrode current collector 14a in each negative electrode 14 projects. The projected current collector 14a is electrically connected to a band-like negative electrode terminal 12. The tip of the band-like negative electrode terminal 12 is extended externally from the outer case 18. Furthermore, although it is not depicted, the side of the positive electrode current collector 13a is projecting and is positioned on the opposite side against the projected side of the negative electrode current collector 14a. The projected positive electrode current collector 13a is electrically connected to a band-like positive electrode terminal 11. The tip of the band-like positive electrode terminal 11 is positioned opposite to the negative electrode terminal 12 and extended externally from the side of the outer case 18.

According to the first embodiment, since a nonaqueous electrolyte comprising the first compound and second compound is used, self-discharge can be suppressed in a nonaqueous electrolyte battery using a negative electrode active material having a lithium absorption potential of 1.0 V (vs Li/Li⁺) or more, and the battery resistance can further be decreased. Therefore, a nonaqueous electrolyte battery having high input/output performance can be provided.

### Second Embodiment

According to the second embodiment, a nonaqueous electrolyte battery comprising a positive electrode, a negative electrode comprising a negative electrode active material having a lithium absorption potential of 1.0 V (vs Li/Li⁺) or more and a nonaqueous electrolyte is provided. The nonaqueous electrolyte comprises the first compound. Furthermore, a coating comprising the second compound is formed on the surface of the negative electrode.

The nonaqueous electrolyte battery according to the second embodiment can be obtained by assembling the nonaqueous electrolyte battery according to the first embodiment, and subjecting the battery to initial charging and discharging.

According to the second embodiment, since the nonaqueous electrolyte comprising the first compound is used and a coating comprising the second compound is formed on the surface of the negative electrode, self-discharge can be suppressed in the nonaqueous electrolyte battery using the negative electrode active material having a lithium absorption potential of 1.0 V (vs Li/Li⁺) or more, and the battery resistance can further be decreased. Therefore, a nonaqueous electrolyte battery having high input/output performance can be provided.

### Third Embodiment

According to the third embodiment, a battery pack comprising the nonaqueous electrolyte battery according to the first embodiment and/or the nonaqueous electrolyte battery according to the second embodiment is provided.

The battery pack is explained with reference to the drawings. The battery pack has one or a plurality of the above-mentioned nonaqueous electrolyte battery (unit cell). When a plurality of unit cells are included, the respective unit cells are disposed electrically in series or parallel.

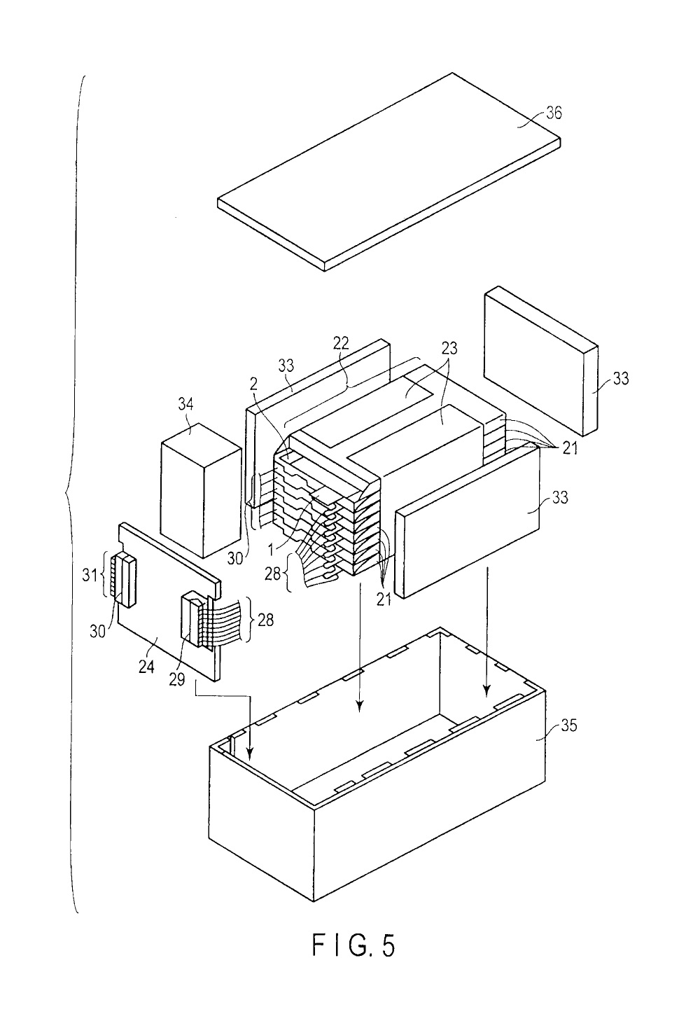

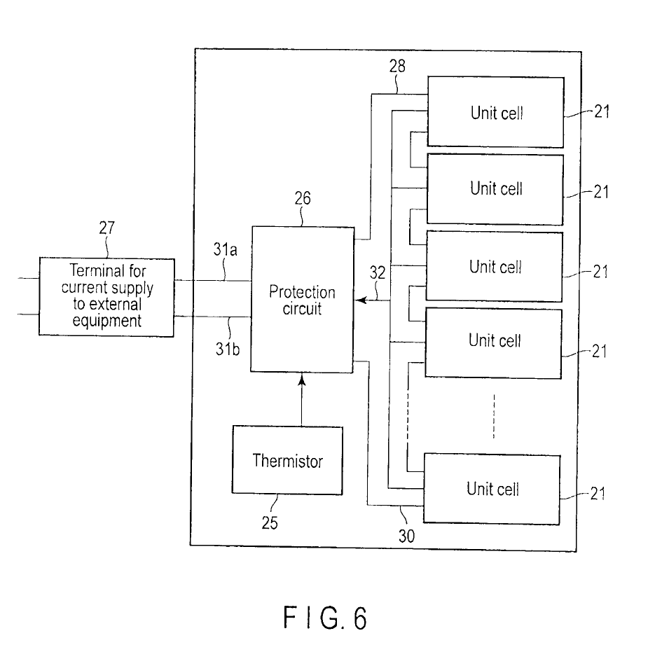

FIGS. 5 and 6 show an example of the battery pack using the flat-type battery shown in FIG. 1. FIG. 5 is an exploded perspective view of the battery pack. FIG. 6 is a block diagram showing the electrical circuit of the battery pack of FIG. 5.

The plural unit cells 21 are stacked one upon the other in the thickness direction in a manner to align the protruding directions of the positive electrode terminals 1 and the negative electrode terminals 2. As shown in FIG. 6, the unit cells 21 are connected in series to form a battery module 22. The unit cells 21 forming the battery module 22 are made integral by using an adhesive tape 23 as shown in FIG. 5.

A printed wiring board 24 is arranged on the side surface of the battery module 22 toward which protrude the positive electrode terminals 1 and the negative electrode terminals 2. As shown in FIG. 6, a thermistor 25, a protection circuit 26 and a terminal 27 for current supply to the external equipment are connected to the printed wiring board 24. In addition, an insulating board (not shown) is attached to the surface of the protection circuit substrate 24, which faces the battery module 22, so as to avoid unnecessary connection with the wiring of the battery module 22.

A wiring 28 on the side of the positive electrodes of the battery module 22 is electrically connected to a connector 29 on the side of the positive electrode of the protection circuit 26 mounted to the printed wiring board 24. On the other hand, a wiring 30 on the side of the negative electrodes of the battery module 22 is electrically connected to a connector 31 on the side of the negative electrode of the protection circuit 26 mounted to the printed wiring board 24.

The thermistor 25 detects the temperature of the unit cell 21 and transmits the detection signal to the protection circuit 26. The protection circuit 26 is capable of breaking a wiring 31a on the positive side and a wiring 31b on the negative side, the wirings 31a and 31b being stretched between the protection circuit 26 and the terminal 27 for current supply to the external equipment. These wirings 31a and 31b are broken by the protection circuit 26 under prescribed conditions including, for example, the conditions that the temperature detected by the thermistor is higher than a prescribed temperature, and that the over-charging, over-discharging and over-current of the unit cell 21 have been detected. The detecting method is applied to the unit cells 21 or to the battery module 22. In the case of applying the detecting method to each of the unit cells 21, it is possible to detect the battery voltage, the positive electrode potential or the negative electrode potential. On the other hand, where the positive electrode potential or the negative electrode potential is detected, lithium metal electrodes used as reference electrodes are inserted into the unit cells 21.

In the case of FIG. 6, a wiring 32 is connected to each of the unit cells 21 for detecting the voltage, and the detection signal is transmitted through these wirings 32 to the protection circuit 26.

Protective sheets 33 each formed of rubber or resin are arranged on the three of the four sides of the battery module 22, though the protective sheet 33 is not arranged on the side toward which protrude the positive electrode terminals 1 and the negative electrode terminals 2. A protective block 34 formed of rubber or resin is arranged in the clearance between the side surface of the battery module 22 and the printed wiring board 24.

The battery module 22 is housed in a container 35 together with each of the protective sheets 33, the protective block 34 and the printed wiring board 24. To be more specific, the protective sheets 33 are arranged inside the two long sides of the container 35 and inside one short side of the container 35. On the other hand, the printed wiring board 24 is arranged along that short side of the container 35 which is opposite to the short side along which one of the protective sheets 33 is arranged. The battery module 22 is positioned within the space surrounded by the three protective sheets 33 and the printed wiring board 24. Further, a lid 36 is mounted to close the upper open edge of the container 35.

Incidentally, it is possible to use a thermally shrinkable tube in place of the adhesive tape 23 for fixing the battery module 22. In this case, the protective sheets 33 are arranged on both sides of the battery module 22 and, after the thermally shrinkable tube is wound about the protective sheets, the tube is thermally shrunk to fix the battery module 22.

The unit cells 21 shown in FIGS. 5 and 6 are connected in series. However, it is also possible to connect the unit cells 21 in parallel to increase the cell capacity. Of course, it is possible to connect the battery packs in series and in parallel. Alternatively, assembled battery packs may be connected with each other in series or parallel.

Furthermore, the embodiment of the battery pack is suitably changed according to its application. The battery pack according to the embodiment is preferably used for applications for which excellent cycle characteristics at a large current are required. Specifically, it is used as a power source for digital cameras, or as an in-car battery for, for example, two to four-wheeled hybrid battery automobiles, two to four-wheeled battery automobiles, and motor assisted bicycles. Specifically, it is preferably used as an in-car battery.

According to the third embodiment, since it comprises the nonaqueous electrolyte battery comprising the first compound and second compound, a battery pack that suppresses self-discharge, has a low battery resistance and has high input/output performance can be provided.

### EXAMPLES

Hereinafter Examples are explained. However, the embodiments should not be construed to be limited to the Examples described below unless they exceed the gist of the embodiments.

### Example A-1

### Preparation of Positive Electrode

As a positive electrode active material, 90% by mass of a lithium-nickel composite oxide (LiNi_{0.8} Co_{0.1}Mn_{0.1}O₂) powder was used. The value of the ph of the positive electrode active material used was measured by putting 2 g of the positive electrode active material in 100 g of distilled water, and the value of the pH was 11.91. As a conductive agent, 3% by mass of acetylene black and 3% by mass of graphite were used. As a binder, 4% by mass of polyvinylidene fluoride (PVdF) was used. The above-mentioned components were added to N-methylpyrrolidone (NMP) and mixed to prepare slurry. This slurry was applied to the both surfaces of a current collector made of an aluminum foil having a thickness of 15 μm, dried and subjected to pressing to give a positive electrode having an electrode density of 3.2 g/cm³.

### <Preparation of Negative Electrode>

A lithium titanate (Li₄Ti₅O₁₂) powder having a spinel structure having an average particle size of 0.84 μm, a BET specific surface area of 10.8 m²/g and a Li absorption potential of 1.56 V (vs. Li/Li⁺) was prepared as the negative electrode active material. The particle size of the negative electrode active material was measured as follows by using a laser-diffraction-type distribution measuring device (Shimadzu SALD-300). First, about 0.1 g of the sample, a surfactant and 1 to 2 mL of distilled water were added to a beaker and stirred thoroughly. This was poured into a stirring water tank, and a luminosity distribution was measured 64 times at intervals of 2 seconds. The obtained particle size distribution data was analyzed to determine a particle size.

90% by mass of the above-mentioned negative electrode active material, 7% by mass of graphite as a conductive agent, and 3% by mass of polyvinylidene fluoride (PVdF) as a binder were used. These components and N-methylpyrrolidone (NMP) were mixed so as to give a solid content proportion of 62% by mass. NMP was added to the obtained mixture to gradually decrease the solid proportion while the mixture was kneaded by a planetary mixer to prepare slurry having a viscosity of 10.2 cp (a type B viscometer, a value at 50 rpm). This slurry was further mixed in a bead mill by using balls made of zirconia each having a diameter of 1 mm as media.

The obtained slurry was applied to the both surfaces of a current collector made of an aluminum foil having a thickness of 15 μm (purity: 99.3% by mass, average crystal grain size: 10 μm) and dried, and roll-pressed by a roll that had been warmed to 100° C. to produce a negative electrode.

### <Preparation of Electrode Group>

As a separator, nonwoven fabric made of cellulose having a thickness of 25 μm was used.

The positive electrode, separator, negative electrode and separator were laminated in this order to give a laminate. This laminate was then wound into a spiral shape. This was heat-pressed at 80° C. to give a flat-shaped electrode group having a height of 100 mm, a width of 70 mm and a thickness of 4 mm. The obtained electrode group was housed in a pack composed of a laminate film having a three-layer structure of a nylon layer/an aluminum layer/a polyethylene layer and having a thickness of 0.1 mm, and dried in vacuum at 80° C. for 16 hours.

### <Preparation of Liquid Nonaqueous Electrolyte>

1 mol/L of LiPF₆ as an electrolyte was dissolved in a mixed solvent of propylene carbonate (PC) and diethyl carbonate (DEC) (ratio by volume: 1:2). Furthermore, 2% by mass of tris(trimethylsilyl) phosphate as the first compound was added and 0.5% by mass of 1,6-diisothiocyanatohexane as the second compound was added with respect to the total mass of the nonaqueous electrolytic solution, and mixed to give a nonaqueous electrolytic solution.

The nonaqueous electrolytic solution was injected in a laminate film pack in which the electrode group was housed, and the pack was sealed off completely by heat-sealing. The assembled nonaqueous electrolyte secondary battery was subjected to a constant current-constant voltage charge operation at a 0.2 C current and a voltage of 2.8 V under a 25° C. environment for 10 hours as initial charging. Then, the battery was discharged at a 0.2 C current up to 1.5 V under a 25° C. environment. Thereafter a cycle comprising a constant current-constant voltage charge operation at a 1 C current and a voltage of 2.8 V under a 25° C. environment for 3 hours and discharging at a 1 C current and a terminal voltage of 1.5 V under a 25° C. environment was repeated twice to give a nonaqueous electrolyte secondary battery having the structure as shown in FIG. 1 and having a height of 110 mm, a width of 72 mm and a thickness of 4 mm.

The negative electrode active material, positive electrode active material, the first compound as added and the added amount thereof, and the second compound as added and the added amount thereof are shown in Table 1.

### Comparative Examples A-1 to A-3, and Examples A-2 to A-7

Nonaqueous electrolyte secondary batteries were each prepared in a similar manner to Example A-1, except that the added amount of tris(trimethylsilyl) phosphate and the added amount of 1,6-diisothiocyanatohexane were changed as shown in Table 1 in the preparation of the nonaqueous electrolytic solution.

### Comparative Examples B-1 to B-2, and Examples B-1 to B-3

Nonaqueous electrolyte secondary batteries were each prepared in a similar manner to Example A-1, except that the first compound and the added amount thereof and the second compound and the added amount thereof were changed as shown in Table 1 in the preparation of the nonaqueous electrolytic solution.

### Comparative Examples C-1 and Example C-1

Nonaqueous electrolyte secondary batteries were prepared in similar manners to Comparative Example A-1 and Example A-1, respectively, except that a monoclinic system p-type TiO₂(B) was used as the negative electrode active material as shown in Table 1. The monoclinic system β-type TiO₂ (B) has a lithium absorption potential of 1 to 2 V (vs Li/Li⁺).

### Comparative Examples D-1 and D-2

Nonaqueous electrolyte secondary batteries were prepared in similar manners to Comparative Example A-1 and Example A-1, respectively, except that graphite having an average particle size of 6 μm was used as the negative electrode active material as shown in Table 1. Graphite has a lithium absorption potential of 0 to 0.2 V (vs Li/Li⁺).

### (Electrochemical Measurements)

The batteries of the Examples and Comparative Examples were each stored in a state at a charging amount of 50% (SOC 50%) under a 60° C. environment for 1 month. The battery was then discharged to obtain a residual capacity, and a residual capacity rate was measured. The residual capacity rate was calculated from (capacity after storage/capacity before storage)×100(%). The results thereof are shown in Tables 2 and 3.

Furthermore, an AC impedance was measured in a state of a charging amount of 50% (SOC 50%) by using each of the batteries of the Examples and Comparative Examples before storage, and an AC resistance (mss) at 1 kHz was obtained. The results thereof are shown in Tables 2 and 3. The resistances were each represented by a ratio using each of the resistances of the batteries of Comparative Examples A-1, C-1 and D-1 in which any additive had not been added to the nonaqueous electrolytic solution as a standard (1.00).

### (Detection of Components)

The components included in the batteries of the Examples and Comparative Examples as prepared before the tests were detected. Specifically, the components included in the electrolytic solution were detected by a gas chromatography-mass spectrometry (GC/MS) to confirm the presence of trimethylsilyl fluoride. Furthermore, when the added amount of the second compound was large, the presence thereof was also confirmed.

Furthermore, a peak was confirmed in the vicinity of about 2060 cm⁻¹ by a Fourier transform infrared spectrophotometer (FT-1R) on the surface of the negative electrode. The presence of the compound having an isothiocyanato group is suggested.

TABLE 1

| | Negative electrode | Positive electrode | | Added amount | | Added amount |
|---|---|---|---|---|---|---|
| | active material | active material | First compound | (% by mass) | Isocyanato compound | (% by mass) |
| Comparative | Li₄Ti₅O₁₂ | LiNi_{0.8}Co_{0.1}Mn_{0.1}O₂ | — | — | — | — |
| Example A-1 | | | | | | |
| Comparative | Li₄Ti₅O₁₂ | LiNi_{0.8}Co_{0.1}Mn_{0.1}O₂ | — | — | 1,6-Diisothiocyanatohexane | 0.5 |
| Example A-2 | | | | | | |
| Comparative | Li₄Ti₅O₁₂ | LiNi_{0.8}Co_{0.1}Mn_{0.1}O₂ | Tris(trimethylsilyl) | 2 | — | — |
| Example A-3 | | | phosphate | | | |
| Example A-1 | Li₄Ti₅O₁₂ | LiNi_{0.8}Co_{0.1}Mn_{0.1}O₂ | Tris(trimethylsilyl) | 2 | 1,6-Diisothiocyanatohexane | 0.5 |
| | | | phosphate | | | |
| Example A-2 | Li₄Ti₅O₁₂ | LiNi_{0.8}Co_{0.1}Mn_{0.1}O₂ | Tris(trimethylsilyl) | 0.05 | 1,6-Diisothiocyanatohexane | 0.05 |
| | | | phosphate | | | |
| Example A-3 | Li₄Ti₅O₁₂ | LiNi_{0.8}Co_{0.1}Mn_{0.1}O₂ | Tris(trimethylsilyl) | 0.5 | 1,6-Diisothiocyanatohexane | 0.05 |
| | | | phosphate | | | |
| Example A-4 | Li₄Ti₅O₁₂ | LiNi_{0.8}Co_{0.1}Mn_{0.1}O₂ | Tris(trimethylsilyl) | 2 | 1,6-Diisothiocyanatohexane | 0.1 |
| | | | phosphate | | | |
| Example A-5 | Li₄Ti₅O₁₂ | LiNi_{0.8}Co_{0.1}Mn_{0.1}O₂ | Tris(trimethylsilyl) | 2 | 1,6-Diisothiocyanatohexane | 1 |
| | | | phosphate | | | |
| Example A-6 | Li₄Ti₅O₁₂ | LiNi_{0.8}Co_{0.1}Mn_{0.1}O₂ | Tris(trimethylsilyl) | 2 | 1,6-Diisothiocyanatohexane | 2 |
| | | | phosphate | | | |
| Example A-7 | Li₄Ti₅O₁₂ | LiNi_{0.8}Co_{0.1}Mn_{0.1}O₂ | Tris(trimethylsilyl) | 5 | 1,6-Diisothiocyanatohexane | 1 |
| | | | phosphate | | | |
| Comparative | Li₄Ti₅O₁₂ | LiNi_{0.8}Co_{0.1}Mn_{0.1}O₂ | — | — | 1,4-Diisothiocyanatobenzene | 0.5 |
| Example B-1 | | | | | | |
| Comparative | Li₄Ti₅O₁₂ | LiNi_{0.8}Co_{0.1}Mn_{0.1}O₂ | Tris(trimethylsilyl) | 2 | — | — |
| Example B-2 | | | borate | | | |
| Example B-1 | Li₄Ti₅O₁₂ | LiNi_{0.8}Co_{0.1}Mn_{0.1}O₂ | Tris(trimethylsilyl) | 2 | 1,4-Diisothiocyanatobenzene | 0.5 |
| | | | phosphate | | | |
| Example B-2 | Li₄Ti₅O₁₂ | LiNi_{0.8}Co_{0.1}Mn_{0.1}O₂ | Tris(trimethylsilyl) | 2 | 1,6-Diisothiocyanatohexane | 0.5 |
| | | | borate | | | |
| Example B-3 | Li₄Ti₅O₁₂ | LiNi_{0.8}Co_{0.1}Mn_{0.1}O₂ | Fluorotrimethylsilane | 0.5 | 1,6-Diisothiocyanatohexane | 0.5 |
| Comparative | TiO₂(B) | LiNi_{0.8}Co_{0.1}Mn_{0.1}O₂ | — | — | — | — |
| Example C-1 | | | | | | |
| Example C-1 | TiO₂(B) | LiNi_{0.8}Co_{0.1}Mn_{0.1}O₂ | Tris(trimethylsilyl) | 2 | 1,6-Diisothiocyanatohexane | 0.5 |
| | | | phosphate | | | |
| Comparative | Graphite | LiNi_{0.8}Co_{0.1}Mn_{0.1}O₂ | — | — | — | — |
| Example D-1 | | | | | | |
| Comparative | Graphite | LiNi_{0.8}Co_{0.1}Mn_{0.1}O₂ | Tris(trimethylsilyl) | 2 | 1,6-Diisothiocyanatohexane | 0.5 |
| Example D-2 | | | phosphate | | | |

TABLE 2

| | | | FT-IR (about 2060 cm⁻¹) | Residual | |
|---|---|---|---|---|---|
| | | | presence or | capacity | 1 kHz AC |
| | Detected component I | Detected component II | absence of peak | rate (%) | resistance |
| Comparative | — | — | Absent | 35 | 1.00 |
| Example A-1 | | | | | |
| Comparative | — | — | Present | 49 | 1.06 |
| Example A-2 | | | | | |
| Comparative | Fluorotrimethylsilane | — | Absent | 32 | 0.98 |
| Example A-3 | | | | | |
| Example A-1 | Fluorotrimethylsilane | — | Present | 56 | 0.92 |
| | Tris(trimethylsilyl) phosphate | | | | |
| Example A-2 | Fluorotrimethylsilane | — | Present | 46 | 0.92 |
| | Tris(trimethylsilyl) phosphate | | | | |
| Example A-3 | Fluorotrimethylsilane | — | Present | 48 | 0.90 |
| | Tris(trimethylsilyl) phosphate | | | | |
| Example A-4 | Fluorotrimethylsilane | — | Present | 48 | 0.90 |
| | Tris(trimethylsilyl) phosphate | | | | |
| Example A-5 | Fluorotrimethylsilane | 1,6-Diisothiocyanatohexane | Present | 66 | 0.91 |
| | Tris(trimethylsilyl) phosphate | | | | |
| Example A-6 | Fluorotrimethylsilane | 1,6-Diisothiocyanatohexane | Present | 69 | 0.93 |
| | Tris(trimethylsilyl) phosphate | | | | |
| Example A-7 | Fluorotrimethylsilane | — | Present | 62 | 0.90 |
| | Tris(trimethylsilyl) phosphate | | | | |

TABLE 3

| | | | FT-IR (about 2060 cm⁻¹) | Residual | |
|---|---|---|---|---|---|
| | | | presence or | capacity | 1 kHz AC |
| | Detected component I | Detected component II | absence of peak | rate (%) | resistance |
| Comparative | — | 1,4-Diisothiocyanatobenzene | Present | 49 | 1.10 |
| Example B-1 | | | | | |
| Comparative | Fluorotrimethylsilane | — | Absent | 31 | 0.99 |
| Example B-2 | | | | | |
| Example B-1 | Fluorotrimethylsilane | 1,4-Diisothiocyanatobenzene | Present | 54 | 0.94 |
| | Tris(trimethylsilyl) phosphate | | | | |
| Example B-2 | Fluorotrimethylsilane | 1,6-Diisothiocyanatohexane | Present | 52 | 0.96 |
| | Tris(trimethylsilyl) borate | | | | |
| Example B-3 | Fluorotrimethylsilane | — | Present | 50 | 0.95 |
| Comparative | — | — | Absent | 23 | 1.00 |
| Example C-1 | | | | | |
| Example C-1 | Fluorotrimethylsilane | 1,6-Diisothiocyanatohexane | Present | 57 | 0.92 |
| Comparative | — | — | Absent | 58 | 1.00 |
| Example D-1 | | | | | |
| Comparative | Fluorotrimethylsilane | 1,6-Diisothiocyanatohexane | Present | 23 | 1.45 |
| Example D-2 | | | | | |

As is apparent from the results in Examples A-1 to A-7 and Comparative Examples A-1 to A-3 in Table 1 to Table 3, the batteries of Examples A-1 to A-7 for which a nonaqueous electrolyte comprising the first compound and second compound was used had a higher residual capacity rate and a lower AC resistance at 1 kHz than those of Comparative Example A-1 for which both the first compound and second compound were not used. Comparative Example A-2 to which only the second compound was added and the first compound was not added had a high residual capacity rate, but also had a high resistance at 1 kHz. Therefore, it was shown that the battery resistance was decreased by adding the first compound. However, the battery of Comparative Example A-3 for which only the first compound was used had a lower residual capacity rate than those of Examples A-1 to A-7. Thus, the battery resistance can be decreased but self-discharge cannot be suppressed by only the first compound.

Therefore, the batteries of Examples A-1 to A-7 cause little self-discharge and have a small battery resistance.

Examples B-1 to B-3 had a higher residual capacity rate and a smaller battery resistance than those of Comparative Example A-1 comprising no additive. Furthermore, they had a higher residual capacity rate and smaller battery resistance than those of Comparative Example B-2 to which the first compound was not added and of Comparative Example B-2 to which the second compound was not added. Therefore, it was shown that the residual capacity rate was high and the battery resistance was decreased also by using tris(trimethylsilyl) borate or fluorotrimethylsilane as the first compound, or by using 1,4-diisothiocyanatobenzene as the second compound.

As shown in the results of Example C-1 and Comparative Example C-1, also when a monoclinic system β-type TiO₂(B) was used as the negative electrode active material instead of lithium titanate, the residual capacity rate was increased and the battery resistance was decreased by using the first compound and second compound.

It was shown by the results of Comparative Examples D-1 and D-2 that, when graphite was used for the negative electrode active material, the battery resistance increased significantly and the residual capacity was low by adding the second compound. This was assumed to be attributed to that the additive was reduced completely on the surface of the negative electrode and the reduction product deposited excessively on the surface of the negative electrode to decrease the battery performance.

In Examples A-1 to A-4 in which the added amount of the second compound was small, the second compound was not detected as Detection of component II, but the presence thereof was detected on the surface of the negative electrode.

Furthermore, it was shown that the first compound such as tris(trimethylsilyl) phosphate and tris(trimethylsilyl) borate was partially converted to fluorotrimethylsilane. In Examples A-1 to A-7, B-1, B-2 and C-1, the detected component I comprised tris(trimethylsilyl) phosphate or tris(trimethylsilyl) borate, and fluorotrimethylsilane.

In all of Examples A-1 to A-7, B-1 to B-3 and C-1 and Comparative Examples A-2, B-1 and D-2 to which the second compound was added, a peak was detected at about 2060 cm⁻¹ by FT-IR, and thus it was shown that the compound having an isothiocyanato group was present on the negative electrode.

For the nonaqueous electrolyte batteries of Example A-1 and Comparative Examples A-1 to A-3, charge and discharge cycle tests of 1 C charging/1 C discharging (1.5 to 2.8 V) were conducted under a 45° C. environment. The capacity ratios (%) at the 1,500th cycle with respect to the initial capacity were summarized in Table 4 as cycle life.

TABLE 4

| | Cycle life (%) |
|---|---|
| Comparative Example A-1 | 81 |
| Comparative Example A-2 | 85 |
| Comparative Example A-3 | 67 |
| Example A-1 | 91 |

As is apparent from Table 4, the battery of Example A-1 for which a nonaqueous electrolyte comprising the first compound and second compound was used had a longer cycle life than those of Comparative Example A-1 for which both the first compound and second compound were not used, Comparative Example A-2 for which only the second compound was added, and Comparative Example A-3 for which only the first compound was used.

### Example E-1 and Comparative Examples E-1 to E-3

Example E-1 and Comparative Examples E-1, E-2 and E-3 were obtained by preparing nonaqueous electrolyte batteries that were similar to those of Example A-1 and Comparative Examples A-1, A-2 and A-3, except that the positive electrode active material was LiMn₂O₄. The residual capacities and AC resistances at 1 kHz were measured by the methods as mentioned previously. The resistances were each represented by a ratio using the resistance of the battery of Comparative Example E-1 in which any additive was not added to the nonaqueous electrolytic solution as a standard (1.00). Furthermore, the batteries as prepared were subjected to charge and discharge cycle tests of 2 C charging/2 C discharging (1.8 to 2.8 V) under a 60° C. environment. The capacity ratios (%) at the 3,000th cycle with respect to the initial capacities were summarized in Table 5 as cycle life.

TABLE 5

| | Residual | | |
|---|---|---|---|
| | capacity | 1 kHz AC | Cycle |
| | rate (%) | resistance | life (%) |
| Comparative | 33 | 1.00 | 70 |
| Example E-1 | | | |
| Comparative | 44 | 1.10 | 73 |
| Example E-2 | | | |
| Comparative | 30 | 0.98 | 80 |
| Example E-3 | | | |
| Example E-1 | 52 | 0.92 | 86 |

As is apparent from Table 5, the battery of Example E-1 for which a nonaqueous electrolyte comprising the first compound and second compound was used had a higher residual capacity and a longer cycle life, and also had a lower resistance than those of Comparative Example E-1 for which both the first compound and second compound were not used, Comparative Example E-2 for which only the second compound was added and Comparative Example E-3 for which only the first compound was used.

### Example F-1 and Comparative Examples F-1 to F-3

Example F-1 and Comparative Examples F-1 to F-3 were obtained by preparing nonaqueous electrolyte batteries that were similar to those of Example A-1 and Comparative Examples A-1, A-2 and A-3 except that the positive electrode active material was LiCoO₂ and that a solution obtained by dissolving 2 M of LiBF₄ in a solvent obtained by mixing ethylene carbonate and γ-butyrolactone by 1:2 was used as the electrolytic solution. The residual capacities and AC resistances at 1 kHz were measured by the methods as mentioned previously. The resistances were each represented by a ratio using the resistance of the battery of Comparative Example F-1 in which any additive was not added to the nonaqueous electrolytic solution as a standard (1.00). Furthermore, the batteries as prepared were subjected to charge and discharge cycle tests of 10 charging/1 C discharging (1.8 to 2.7 V) under a 45° C. environment. The capacity ratios at the 1,000th cycle with respect to the initial capacities were summarized in Table 6 as cycle life.

TABLE 6

| | Residual | | |
|---|---|---|---|
| | capacity | 1 kHz AC | Cycle |
| | rate (%) | resistance | life (%) |
| Comparative | 37 | 1.00 | 85 |
| Example F-1 | | | |
| Comparative | 52 | 1.07 | 94 |
| Example F-2 | | | |
| Comparative | 35 | 0.98 | 87 |
| Example F-3 | | | |
| Example F-1 | 60 | 0.94 | 97 |

As is apparent from Table 6, the battery of Example F-1 for which a nonaqueous electrolyte comprising the first compound and second compound was used had a higher residual capacity and a longer cycle life and also had a lower resistance than those of Comparative Example F-1 for which both the first compound and second compound were not used, Comparative Example F-2 for which only the second compound was added and Comparative Example F-3 for which only the first compound was used.

When 1,2-diisothiocyanatoethane, 1,3-diisothiocyanatopropane, 1,4-diisothiocyanatobutane, 1,5-diisothiocyanatopentane, 1,7-diisothiocyanatoheptane or 1,8-diisothiocyanatoctane was used instead of 1,6-diisothiocyanatohexane as the second compound in Example A-1, the residual capacity was high and the battery resistance was low as in Example A-1.

According to the Examples as explained above, since the first compound and second compound are included, a nonaqueous electrolyte battery that provides small self-discharge and has a low resistance and a long life can be attained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte battery, which comprises
a positive electrode;
a negative electrode comprising a negative electrode active material having a lithium absorption potential of 1.0 V (vs Li/Li⁺) or more; and
a nonaqueous electrolyte comprising a first compound having a functional group represented by the chemical formula (I) and a second compound having an isothiocyanato group: 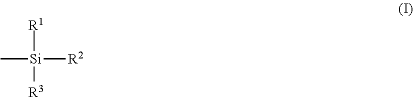
wherein R¹, R² and R³ are each an alkyl group having 1 to 10 carbon atoms, an alkenyl group having 2 to 10 carbon atoms or an aryl group having 6 to 10 carbon atoms, and R¹, R² and R³ may be the same or different with each other.

2. The battery according to claim 1, wherein the first compound comprises at least one selected from the group consisting of a phosphate compound represented by the chemical formula (I) and a borate compound represented by the chemical formula (I).

3. The battery according to claim 1, wherein the R¹, R² and R³ are each a methyl group or an ethyl group.

4. The battery according to claim 1, wherein the first compound is at least one selected from the group consisting of tris(trimethylsilyl) phosphate and fluorotrimethylsilane.

5. The battery according to claim 1, wherein a content of the first compound in the nonaqueous electrolyte is from 0.05% by mass to 5% by mass.

6. The battery according to claim 1, wherein the second compound is at least one selected from the group consisting of a compound represented by the chemical formula (II) and a compound represented by the chemical formula (III):
R-NCS (II)
NCS-R-NCS (III)
wherein R is a chain hydrocarbon group having 1 to 10 carbon atoms.

7. The battery according to claim 6, wherein the R is a chain hydrocarbon group having 1 to 8 carbon atoms.

8. The battery according to claim 1, wherein the second compound is at least one compound selected from the group consisting of 1,2-diisothiocyanatoethane, 1,3-diisothiocyanatopropane, 1,4-diisothiocyanatobutane, 1,4-diisothiocyanatobenzene, 1,8-diisothiocyanatopentane, 1,6-diisothiocyanatohexane, 1,7-diisothiocyanatoheptane and 1,8-diisothiocyanatoctane.

9. The battery according to claim 1, wherein a content of the second compound in the nonaqueous electrolyte is in the range from 0.05% by mass to 2% by mass.

10. The battery according to claim 1, wherein the negative electrode active material is a lithium-titanium composite oxide.

11. The battery according to claim 10, wherein the lithium-titanium composite oxide has a cubic system spinel-type structure or a monoclinic system β-type structure.

12. A battery pack comprising the nonaqueous electrolyte battery according to claim 1.

13. A nonaqueous electrolyte battery, which comprises
a positive electrode;
a negative electrode comprising a negative electrode active material having a lithium absorption potential of 1.0 V (vs Li/Li⁺) or more, and the negative electrode having a coating comprising a second compound having an isothiocyanato group formed on the surface thereof; and
a nonaqueous electrolyte comprising a first compound having a functional group represented by the chemical formula (I): 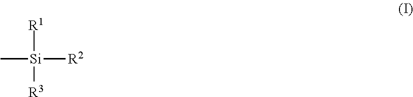
wherein R¹, R² and R³ are each an alkyl group having 1 to 10 carbon atoms, an alkenyl group having 2 to 10 carbon atoms or an aryl group having 6 to 10 carbon atoms, and R¹, R² and R³ may be the same or different with each other.

14. The battery according to claim 13, wherein the first compound comprises at least one selected from the group consisting of a phosphate compound represented by the chemical formula (I) and a borate compound represented by the chemical formula (I).

15. The battery according to claim 13, wherein the first compound is at least one selected from the group consisting of tris(trimethylsilyl) phosphate and fluorotrimethylsilane.

16. The battery according to claim 13, wherein a content of the first compound in the nonaqueous electrolyte is from 0.05% by mass to 5% by mass.

17. The battery according to claim 13, wherein the second compound is at least one selected from the group consisting of a compound represented by the chemical formula (II) and a compound represented by the chemical formula (III):
R-NCS (II)
NCS-R-NCS (III)
wherein R is a chain hydrocarbon group having 1 to 10 carbon atoms.

18. The battery according to claim 13, wherein the second compound is at least one compound selected from the group consisting of 1,2-diisothiocyanatoethane, 1,3-diisothiocyanatopropane, 1,4-diisothiocyanatobutane, 1,4-diisothiocyanatobenzene, 1,5-diisothiocyanatopentane, 1,6-diisothiocyanatohexane, 1,7-diisothiocyanatoheptane and 1,8-diisothiocyanatoctane.

19. The battery according to claim 13, wherein a content of the second compound in the nonaqueous electrolyte is in the range from 0.05% by mass to 2% by mass.

20. A battery pack comprising the nonaqueous electrolyte battery according to claim 13.
